(19) United States
(12) Patent Application Publication
(10) Pub. No.: US 2014/0063540 A1
(43) Pub. Date: Mar. 6, 2014

(54) SERVER APPARATUS AND CONTROL METHOD THEREOF

(71) Applicants: Toshiba Tec Kabushiki Kaisha, Tokyo (JP); Kabushiki Kaisha Toshiba, Tokyo (JP)

(72) Inventors: Tomonori IKUMI, Shizuoka (JP); Naoki WATANABE, Tokyo (JP); Mika HIRAMA, Tokyo (JP); Masami TAKAHATA, Tokyo (JP); Akihiko FUJIWARA, Kanagawa (JP)

(21) Appl. No.: 13/942,485

(22) Filed: Jul. 15, 2013

(30) Foreign Application Priority Data
Aug. 30, 2012 (JP) 2012-190420

(51) Int. Cl. H04N 1/00

(52) U.S. Cl. CPC H04N 1/00506
USPC 358/1.15

(57) ABSTRACT

A server apparatus includes a storage section configured to store information related to a selection screen for selecting a printed object, a changing section configured to change the information related to the selection screen stored in the storage section and an interface configured to accept a change instruction for the changing section. The server apparatus is capable of communicating with an operation/display section through the interface, and the change instruction can be generated by operating the operation/display section.

### CROSS-REFERENCE TO RELATED APPLICATION

This application is based upon and claims the benefit of priority from Japanese Patent Application No. 2012-190420, filed Aug. 30, 2012, the entire contents of which are incorporated herein by reference.

### FIELD

Embodiments described herein relate to a server apparatus having an input-output interface for data to be printed.

### BACKGROUND

In recent years, an on-demand printing system using a multifunctional peripheral (hereinafter, referred to as “MFP”) configured in a store and the like to print a document acquired from a server apparatus by communication has been adopted. Operation panel information and documents that can be displayed on the operation panel of the MFP and printed by the MFP are stored in a storage section of the server apparatus. A user can select the document using the operation panel of the MFP, and print the selected document by issuing a printing instruction.

### BRIEF DESCRIPTION OF THE DRAWINGS

FIG. 1 is a functional block diagram of an on-demand printing system;

FIG. 2 illustrates interior components of an MFP;

FIG. 3 is a flow chart illustrating the basic process of the on-demand printing system before the on-demand printing system begins change processing;

FIG. 4 is a flow chart illustrating steps of a printing process;

FIG. 5 is a flow chart illustrating steps of a document registration process;

FIG. 6 is a flow chart illustrating steps of customizing a selection screen.

### DETAILED DESCRIPTION

Generally, according to one embodiment, a server apparatus includes a storage section configured to store information related to a selection screen for selecting a printed object, a changing section configured to change the information related to the selection screen stored in the storage section, and an interface configured to accept a change instruction for the changing section.

Embodiments provide a technology that a user and the like employs to carryout the customization of a selection screen for a document to be printed and the change of the printed object according to a state of carrying out on-demand printing.

Hereinafter, the embodiment is described with reference to accompanying drawings.

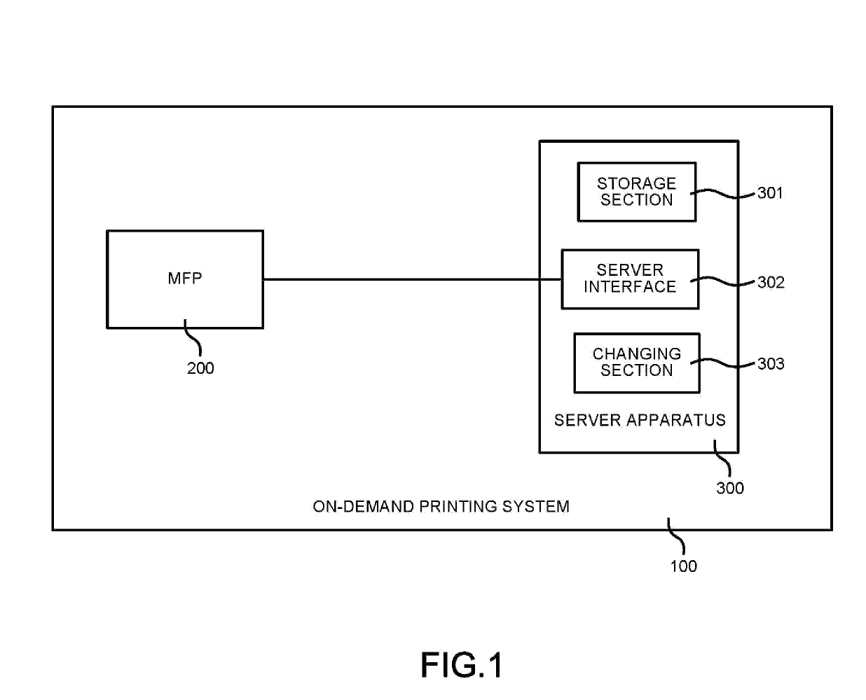

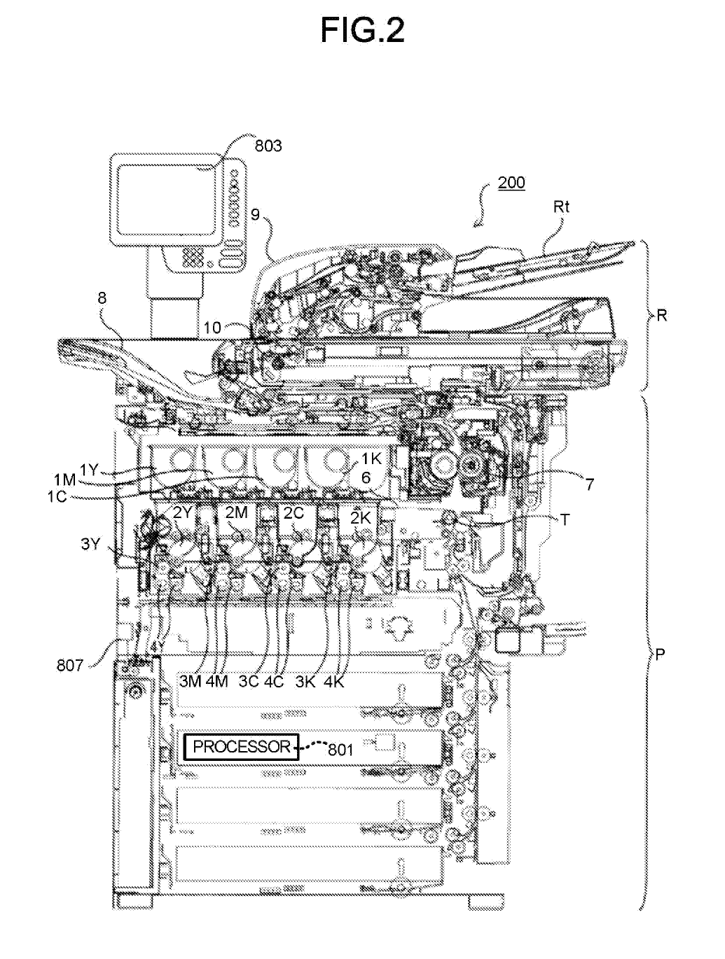

FIG. 1 is a functional block diagram of an on-demand printing system. FIG. 2 illustrates interior components of an MFP. Referring to FIG. 1, the on-demand printing system 100 comprises an MFP 200 and a server apparatus 300. Referring to FIG. 2, the MFP 200 comprises an image reading section R and an image forming section P. The image reading section R scans the images of a paper document or a book document to read them.

The image forming section P forms a developer image on paper according to the image read from the document by the image reading section R or the printed document sent to the MFP 200 by the server apparatus 300.

The image reading section R includes an auto document feeder (ADF: Auto Document Feeder) 9 that automatically feeds a document to a specified image reading position. The image reading section R reads a document placed on a document tray (specified document placing table) Rt that is automatically fed by the auto document feeder 9 or an image of a document placed on a document table not shown in figures, by a scanning optical system 10.

In addition, the image forming section P comprises toner cartridges 1Y, 1M, 1C, 1K, photoreceptors 2Y, 2M, 2C, 2K, developing rollers 3Y, 3M, 3C, 3K, mixers 4Y, 4M, 4C, 4K, an intermediate transfer belt 6, a fixing apparatus 7 and a discharge tray 8.

In addition, the MFP 200 according to the embodiment comprises a processor 801, an operation/display section 803 and an MFP interface 807. The processor 801 has a function of carrying out various kinds of processing in the MFP 200, and in addition, also has a function of realizing various functions by executing a program stored in memory (not shown in the figures). The memory, for example, may be a RAM (Random Access Memory), a ROM (Read Only Memory), a DRAM (Dynamic Random Access Memory), a SRAM (Static Random Access Memory) and a VRAM (Video RAM), and has a function of storing various kinds of information or the program utilized to operate the MFP 200.

Various settings are displayed on the operation/display section 803. The operation/display section 803 may be an LCD (Liquid Crystal Display), an EL (Electronic Luminescence) display, a PDP (Plasma Display Panel) and a CRT (Cathode Ray Tube) display. The user can instruct image formation for the image forming section P by operating the operation/display section 803. In addition, operation panel information stored in the server apparatus 300 can be displayed on the operation/display section 803 by a browser. The user can select a document intended to be printed after some filtering processing and the like which is based on page transitions or attribute information of the document, similar to a general internet operation, by touching an icon and the like on the browser.

In addition, the user can change the information (hereinafter, referred to as customization object information) related to the display method of the selection screen for selecting the printed document stored in the server apparatus 300 by operating the operation/display section 803. In addition, the same user or another user can carry out the on-demand printing next time by registering the information of the paper scanned by using the image reading section R in the server apparatus 300 as a document.

Referring to FIG. 1 again, the server apparatus 300 comprises a storage section 301, a server interface 302 and a changing section 303. The storage section 301 stores customization object information. Herein, the information related to the background of the selection screen, the information related to the definition of the header and the footer of the selection screen, the information related to the definition of a button and the information related to screen transition are included in the customization object information. The so-called information related to the screen transition refers to the information deciding a screen sequence transitioning from a standby screen to a printing ending screen.

The server apparatus 300 carries out bidirectional communication with the MFP 200 through the server interface 302. The changing section 303 changes the customization object information stored by the storage section 301 according to operation information generated by operating the operation/display section 803 of the MFP 200. Herein, as described below, the document stored by the storage section 301 can be added and cancelled by operating the operation/display section 803 of the MFP 200. Adding and cancelling the printed document are types of the change of the customization object information.

Herein, the storage section 301 may be a RAM (Random Access Memory), a ROM (Read Only Memory), a DRAM (Dynamic Random Access Memory), a SRAM (Static Random Access Memory) and a VRAM (Video RAM). The changing section 303 may be a processor, or an ASIC circuit configured to execute at least one portion of the processing carried out by the processor.

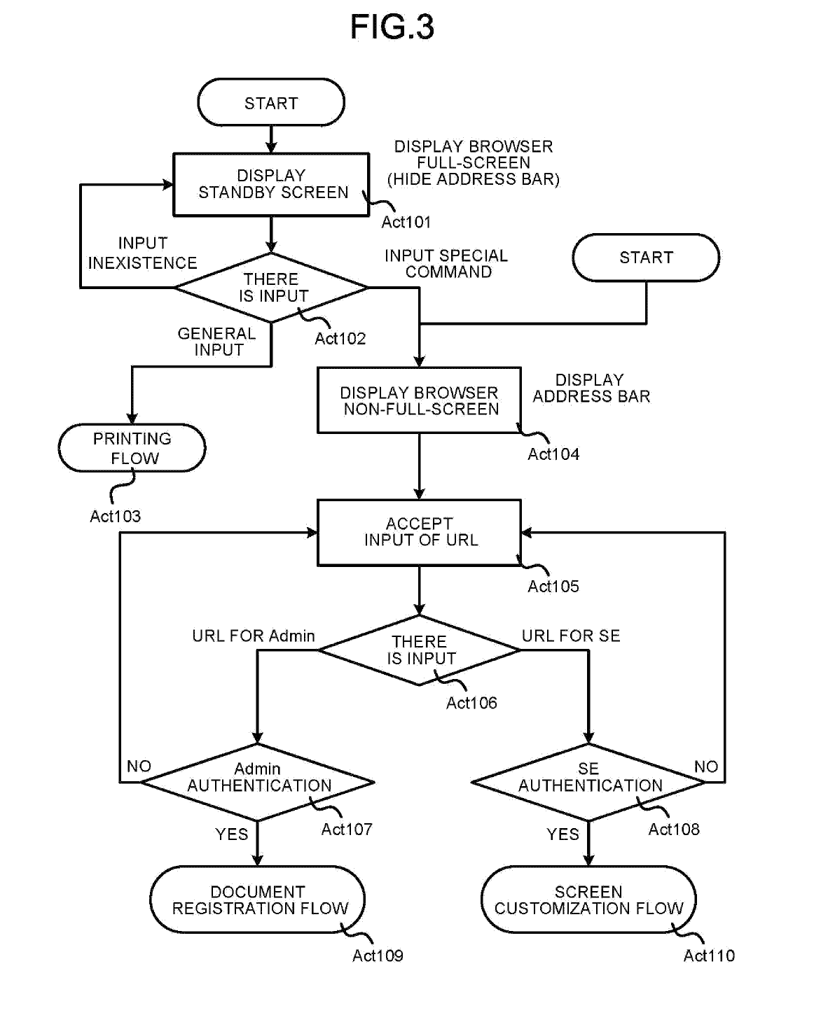

Next, the usage method of the on-demand printing system 100 is described with reference to flow charts in FIG. 3 to FIG. 6. In the flowcharts, the users of the on-demand printing system 100 consist of an end user, an administration user (hereinafter, referred to as admin user), a system engineer user (hereinafter, referred to as SE user) are defined. The end user can carry out printout only. The admin user can carry out the registration processing of the printed document as part of the change processing which changes the customization object information. The SE user can carry out the process of customizing the screen as part of the change processing which changes the customization object information.

The basic process of the on-demand printing system before it begins change processing are described with reference to FIG. 3. The flow shown in FIG. 3 is the processing carried out by the processor 801. In ACT101, the processor 801 uses the browser to display the standby screen on the operation/display section 803. The browser may be the “Internet Explorer”, the “Safari”, the “Google Chrome” and the “Firefox”. In ACT102, when the standby screen is generally operated, the processing proceeds to a printing flow in ACT103. Herein, a so-called general operation means touching the standby screen. A special button corresponding to the general operation is displayed on the operation/display section 803, and the operation of touching the button may be the general operation. The details of the printing flow is described later.

In ACT102, when a special command is input, the processing proceeds to ACT104. The special command is input by operating the special button displayed by the operation/display section 803. When the special command is input, the processing proceeds to ACT104.

In ACT104, the processor 801 switches the display mode of the operation/display section 803 into a non-full-screen mode of the browser, and displays an address bar. Generally, when the browser is displayed in a full-screen mode, content is only displayed, and the functional area of the browser, such as a taskbar and the like, is not displayed. Therefore, it is necessary to display the address bar by operating the special button and switching the display mode of the operation/display section 803 into a non-full-screen mode. In addition, when the browser has been displayed in a non-full-screen mode on the operation/display section 803, the processing can be also started from ACT104.

In ACT105, the processor 801 accepts the input of a URL into the address bar displayed by the operation/display section 803. In ACT106, the processor 801 distinguishes whether the input address is an URL for an SE user or an URL for an admin user. When the input URL is for the admin user, the processing proceeds to ACT107, and when the input URL is for the SE user, the processing proceeds to ACT108.

In ACT107, the processor 801 requires the input of a password and a user ID. When the admin authentication is accepted (Yes in ACT107), the processing proceeds to the registration flow of the printed document in ACT109, and when the admin authentication is refused (No in ACT107), it returns to ACT105, and the screen returns to an accepting screen for accepting the input of the URL.

In ACT108, the processor 801 requires the input of a password and a user ID. When the SE authentication is accepted (Yes in ACT108), the processing proceeds to a screen customization flow in ACT110, and when the SE authentication is refused (No in ACT108), it returns to ACT105, and the screen returns to an accepting screen accepting the input of the URL.

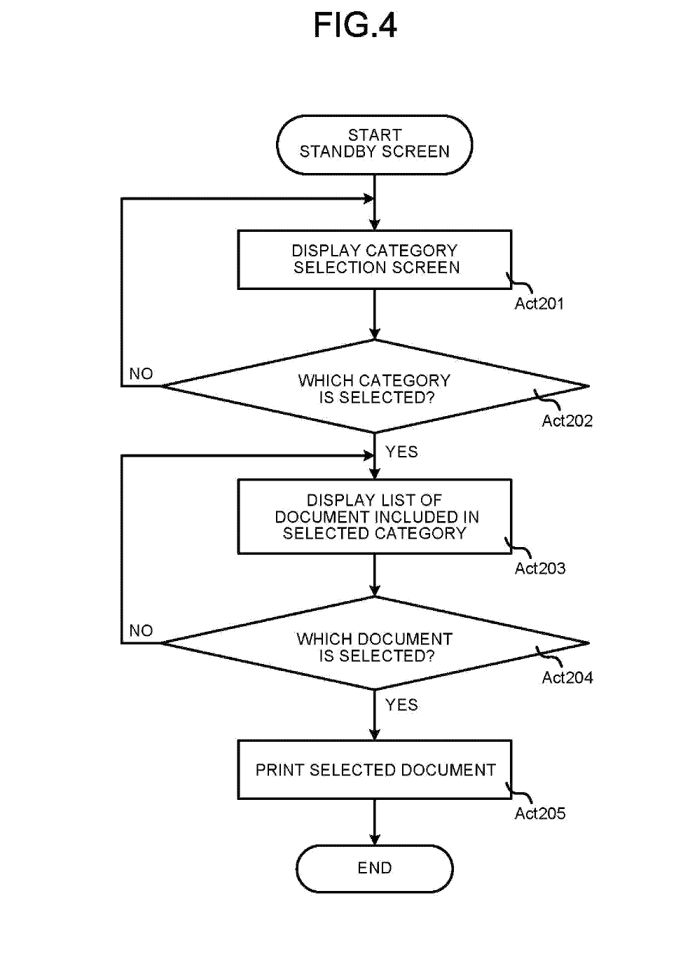

The steps of a printing process are illustrated in the flow chart in FIG. 4. In ACT201, the processor 801 enables the operation/display section 803 to display a category selection screen. Buttons denoting the name of each category stored by the server apparatus 300 are displayed on the category selection screen. Herein, the so-called category refers to a classification classifying each document. For example, when the present on-demand printing system is arranged in an administrative organization, the printed document may be classified according to each category such as “Citizen”, “Revenue”, “Welfare”, “Child Care Support”, “Health” and the like. In addition, buttons arranged in correspondence with the text information such as “Citizen”, “Revenue”, “Welfare”, “Child Care Support”, “Health” are displayed on the category selection screen.

In ACT202, the processor 801 distinguishes which category is selected. When none of the categories is selected in ACT202 (No in ACT202), it returns to ACT201, and the processor 801 continues displaying of the category selection screen. When a category is selected in ACT202 (Yes in ACT202), the processing proceeds to ACT203. In ACT203, the processor 801 displays a list of documents included in the selected category on the operation/display section 803. For example, when the “Child Care Support” is selected, the list of each document such as “Announcement from Children's house”, “Information of Nursery Waiting List” is displayed. Herein, the list of the document may also be a file name, a text name denoting what content it is and a thumbnail which provides a preview of the actual printed content.

In ACT204, the processor 801 distinguishes which document is selected. When no document is selected (No in ACT204), the processing is returned to ACT203, and the display of a document list selection screen is continued.

In ACT205, the processor 801 acquires the selected document from the server apparatus 300 and enables the MFP 200 to execute printing processing.

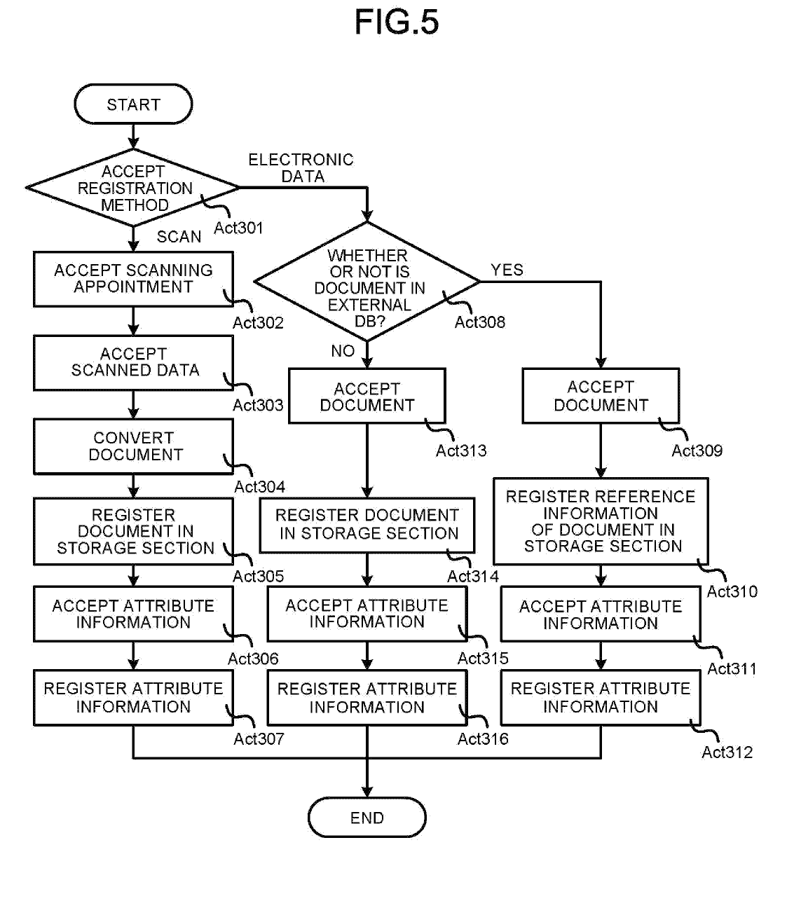

The flow chart in FIG. 5 illustrates the steps of a registration process of the document to be printed. In ACT301, the processor 801 distinguishes whether the registration method for the printed document is scanning or electronic data. When the registration method is scanning, the processor 801 accepts the scanning appointment in ACT302. In ACT303, the server apparatus 300 acquires the data scanned by the MFP 200 through the server interface 302.

In ACT304, the changing section 303 converts the acquired data into a document. In ACT305, the changing section 303 stores the document in the storage section 301. In ACT306, the changing section 303 accepts the attribute information input to the operation/display section 803 through the server interface 302. In ACT307, the changing section 303 stores the attribute information in the storage section 301. Herein, for example, when the object of the document is a car, the so-called attribute information refers to “Company name”, “Car model (EV, HV, etc.)”, “Price” and the like, and the admin user can freely set the attribute information. The end user can carryout the filtering processing of the attribute information by operating the operation/display section 803, and print the document included in the expected attribute information.

In ACT301, when the registration method is identified as electronic data, the changing section 303 distinguishes whether or not the electronic data is the document which is supposed to be stored in an external server (not shown in figures) configured outside the server apparatus 300 in ACT308. When the electronic data is the document supposed to be stored in the external server (Yes in ACT308), the changing section 303 accepts the document in ACT309, and the processing proceeds to ACT310. In ACT310, the changing section 303 only stores the reference information of the document in the storage section 301 and sends the data of the document to the external server. Herein, the so-called reference information of the document refers to the document name of the document and the address information of a storage address. In addition, the document sent to the external server is stored in the external server.

In ACT311, the changing section 303 accepts the attribute information input to the operation/display section 803 through the server interface 302. In ACT312, the changing section 303 stores the attribute information in the storage section 301. Herein, when the end user prints the document stored in the external server, the server apparatus 300 can acquire the document stored in the storage server through the server interface 302, and send it to the MFP 200. Thus, the document stored in the external server can be printed by using the MFP 200. In addition, as the processing of completely transferring the document stored by the external server to the server apparatus 300 is not needed, the work load when the present on-demand printing system is set can be decreased.

When the electronic data is not the document supposed to be stored in the external server (No in ACT308), in ACT313, the changing section 303 accepts the document, and the processing proceeds to ACT314. In ACT314, the changing section 303 stores the document in the storage section 301. In ACT315, the changing section 303 accepts the attribute information input to the operation/display section 803 through the server interface 302. In ACT316, the changing section 303 stores the attribute information in the storage section 301.

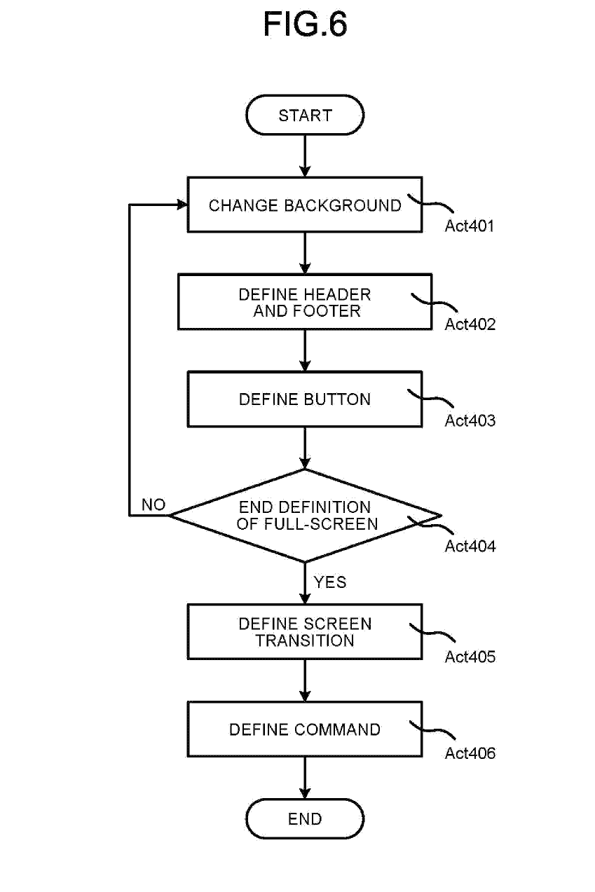

Next, the screen customization flow is described with reference to FIG. 6. In ACT401, the changing section 303 sends the screen information for changing the background to the MFP 200. The screen information sent to the MFP 200 is displayed on the operation/display section 803 by the processor 801. The user can select an expected background screen from a plurality of background screens displayed by the operation/display section 803. The selection information of the background screen is sent to the server apparatus 300 and is stored in the storage section 301.

In ACT402, the changing section 303 sends the screen information for defining the header and the footer to the MFP 200. The screen information sent to the MFP 200 is displayed on the operation/display section 803 by the processor 801. Herein, the so-called definition of the header and the footer is to determine the name displayed by the header and the footer. The definition information of the header and the footer is sent to the server apparatus 300 and is stored in the storage section 301.

In ACT403, the changing section 303 sends the screen information for defining the button to the MFP 200. The screen information sent to the MFP 200 is displayed on the operation/display section 803 by the processor 801. For example, when the on-demand printing system is applied in a window application-oriented system which is arranged in a ward office, such a button of “Living in city” and “Living outside city” can be displayed on the operation/display section 803. The information of the button whose name is determined is sent to the server apparatus 300 and is stored in the storage section 301.

In ACT404, the changing section 303 distinguishes whether or not “Background change”, “Definition of Header and Footer” and “Definition of Button” have been defined for the full-screen. When they have been defined completely (Yes in ACT404), the processing proceeds to ACT405. When they have not been defined completely (No in ACT404), the processing is returned to ACT401, and “Background change”, “Definition of Header and Footer” and “Definition of Button” are repeated.

In ACT405, the changing section 303 sends the screen information for defining the screen transition to the MFP 200. The screen information sent to the MFP 200 is displayed on the operation/display section 803 by the processor 801. The information related to the defined screen transition is sent to the server apparatus 300 and is stored in the storage section 301. The screen transition is as described above, and therefore, it description is not repeated here.

In ACT406, the changing section 303 sends the screen information for defining the command to the MFP 200. The screen information sent to the MFP 200 is displayed on the operation/display section 803 by the processor 801. The command, for example, may be “Return the screen to the standby screen when an icon of ‘To top’ displayed at the footer is selected”, “Display the application in a format A on the operation/display section 803 when a button of ‘Living in city’ is touched” and “Display the application in a format B on the operation/display section 803 when a button of ‘Living outside city’ is touched”.

### Modified Example 1

In the embodiment mentioned above, the information related to the display method of the selection screen and stored in the server apparatus 300 is changed by sending the operation information generated by operating the operation/display section 803 of the MFP 200 to the server apparatus 300, but the present embodiment can be also applicable to the MFP 200 with a server section. In such a modified system, the information related to the display method of the selection screen can be changed by receiving the operation information generated by operating the operation/display section 803 in the interface of the server section.

### Modified Example 2

In the embodiment mentioned above, the on-demand printing system comprising the MFP 200 and the server apparatus 300 is described, but the present embodiment is not limited to this. The present embodiment can be also applicable to a system comprising an operation device (for example, an operation panel) and the server apparatus 300. In such a modified system, the information related to the display method of the selection screen and stored in the server apparatus 300 can be corrected by operating the operation panel.

In the disclosed embodiments, the processing can be accomplished by a computer-executable program, and this program can be realized in a computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above. Furthermore, based on an indication of the program installed from the memory device to the computer, OS (operation system) operating on the computer, or MW (middleware software), such as database management software or network, may execute one part of each processing to realize the embodiments.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A server apparatus, comprising:
a storage section configured to store information related to a selection screen for selecting a printed object;
a changing section configured to change the information related to the selection screen stored in the storage section; and
an interface configured to accept a change instruction for the changing section.

2. The server apparatus according to claim 1, wherein
the server apparatus is capable of communicating with an operation/display section of an image forming apparatus through the interface over a network; and
the change instruction is generated by operating the operation/display section.

3. The server apparatus according to claim 1, wherein the change instruction for the changing section specifies a change in a background of the selection screen.

4. The server apparatus according to claim 1, wherein the change instruction for the changing section specifies a change in a header/footer portion of the selection screen.

5. The server apparatus according to claim 1, wherein the change instruction for the changing section specifies a change in a text of a button appearing on the selection screen.

6. The server apparatus according to claim 5, wherein the change instruction for the changing section also changes a function associated with the button appearing on the selection screen.

7. The server apparatus according to claim 1, wherein the selection screen includes a plurality of linked screens and the change instruction for the changing section defines transitions between the linked screens.

8. The server apparatus according to claim 1, further comprising:
an operation/display section,
wherein the change instruction is generated by operating the operation/display section.

9. A control method of a server apparatus, comprising:
storing information related to a selection screen for selecting a printed object;
receiving a change instruction; and
changing the information related to the selection screen according to the change instruction.

10. The control method of a server apparatus according to claim 9, wherein the change instruction is received from an operation/display section of an image forming apparatus through communication over a network.

11. The control method of a server apparatus according to claim 9, wherein the change instruction is received from an operation/display section of the server apparatus.

12. The control method according to claim 9, wherein the change instruction for the changing section specifies a change in a background of the selection screen.

13. The control method according to claim 9, wherein the change instruction for the changing section specifies a change in a header/footer portion of the selection screen.

14. The control method according to claim 9, wherein the change instruction for the changing section specifies a change in a text of a button appearing on the selection screen.

15. The control method according to claim 14, wherein the change instruction for the changing section also changes a function associated with the button appearing on the selection screen.

16. The control method according to claim 9, wherein the selection screen includes a plurality of linked screens and the change instruction for the changing section defines transitions between the linked screens.

17. An image forming apparatus, comprising:
a server apparatus including a storage section configured to store information related to a selection screen for selecting a printed object, a changing section configured to change the information related to the selection screen stored in the storage section, and an interface configured to accept a change instruction for the changing section; and
an operation/display section, wherein the change instruction is generated by operating the operation/display section.

18. The image forming apparatus according to claim 17, wherein the selection screen includes a plurality of linked screens and the change instruction for the changing section defines transitions between the linked screens.

19. The image forming apparatus according to claim 17, wherein the storage section includes a plurality of documents that have been registered after the documents have been received over a network from an external server.
